(19) United States
(12) Patent Application Publication
(10) Pub. No.: US 2012/0173394 A1
(43) Pub. Date: Jul. 5, 2012

(54) DEVICE AND METHOD FOR ALLOCATING REVENUE AMONG PROVIDERS OF BUNDLED OFFERINGS

(76) Inventors: Qiong Wang, Millington, NJ (US); Ramesh Nagarajan, Princeton Junction, NJ (US)

(21) Appl. No.: 12/984,690

(22) Filed: Jan. 5, 2011

(51) Int. Cl. G06Q 30/00

(52) U.S. Cl. 705/30

(57) ABSTRACT

An exemplary device for allocating revenue among providers of products that are offered together for purchase as part of a unit includes a processor that is configured to automatically determine a number of unit or offering purchases. The processor is configured to automatically issue a corresponding number of virtual shares to each of the providers. The number of virtual shares issued to each provider is based on the number of unit or offering purchases and a predetermined allocation of a number of virtual shares for each provider, respectively for each purchase. The processor is also configured to determine a value of each issued virtual share using at least one selected revenue sharing rule according to a determined schedule. A virtual share redemption module facilitates payment responsive to redemption of issued virtual shares at the determined value.

### BACKGROUND

There are a variety of ways that products and services are marketed today. With the proliferation of technology, a variety of different options are available to consumers. For example, it is possible to obtain goods or services through purchases made on the Internet, phone-in orders, catalogs or retail outlets. Additionally, companies in various industries have attempted to attract consumers by bundling goods or services together and offering them as a packaged unit. For example, a family may acquire phone service, Internet access and television programming bundled together for a single monthly payment instead of purchasing each of those individually and paying for them separately.

There are circumstances in which a single provider may be able to bundle a variety of products that it offers. There are circumstances, however, when different products or services from different providers can advantageously be bundled together to increase the likelihood of selling the corresponding goods or services.

One challenge associated with different providers bundling goods or services together is how to allocate revenue resulting from sales among the different providers of the different products. One proposal is to pay each of the providers a fixed price for each sale or use of their good or service that is packaged with the others. This approach, however, imposes a substantial monetary risk on the seller of the package. In some circumstances, a provider of one of the goods according to the fixed price schedule may effectively require more payment than that which is received by the seller of the package or bundle.

Alternatively, it has been proposed to simply share revenue on a percentage basis. One drawback associated with this approach is that the percentage can be arbitrary and there is no unified mechanism for a seller to deal with multiple sub-good venders to achieve a satisfactory percentage allocation.

### SUMMARY

An exemplary device for allocating revenue among providers of products that are offered together for purchase as part of a unit includes a processor that is configured to automatically determine a number of unit or offering purchases. The processor is configured to automatically issue a corresponding number of virtual shares to each of the providers. The number of virtual shares issued to each provider is based on the number of unit or offering purchases and a predetermined allocation of a number of virtual shares for each provider, respectively for each purchase. The processor is also configured to determine a value of each issued virtual share using at least one selected revenue sharing rule according to a determined schedule. A virtual share redemption module facilitates payment responsive to redemption of issued virtual shares at the determined value.

An exemplary method of allocating revenue among providers of offerings that are marketed together as part of a unit includes determining an allocation of a number of virtual shares for each provider, respectively, for each purchase of an offering or unit. A processor is used for automatically monitoring a number of offering or unit purchases. The processor is also used for automatically issuing a corresponding number of virtual shares to each of the providers based on the number of purchases. The processor also determines the value of each issued virtual share using at least one selected revenue sharing rule according to a determined schedule. The method includes facilitating payment responsive to redemption of issued virtual shares at the determined value.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates a scenario in which different offerings from different providers are marketed together for sale as a unit.

FIG. 2 schematically illustrates a device for allocating revenue among the providers based upon unit sales.

FIG. 3 is a flowchart diagram summarizing an example approach of allocating revenue among the providers.

### DETAILED DESCRIPTION

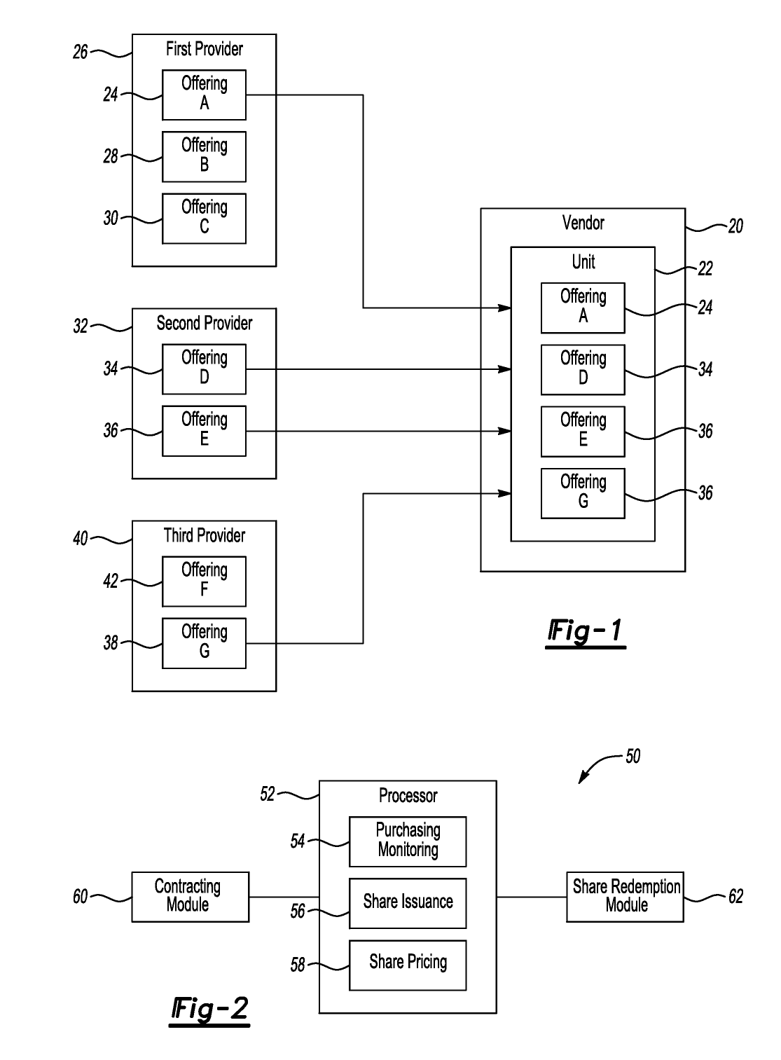

FIG. 1 schematically illustrates an arrangement in which a vendor 20 markets a bundled or packaged unit 22 that includes a plurality of offerings from different sources or providers. This description uses the term “offering” to refer to a product, good or service, for example, that may be purchased by a consumer as part of a packaged unit. Within this description, the terms “purchase” and “sale” includes an exchange of payment for any one of (i) acquiring an offering or a bundled unit of offerings, (ii) a use of an offering or a packaged unit of offerings or (iii) access to such an offering. Depending on the particular offerings involved, a consumer may acquire them, subscribe to a service or may pay on a per-use basis and, in any one of those cases, the transaction can be considered a purchase for discussion purposes.

In the illustrated example, the unit 22 includes an offering A 24 that is available from a first provider 26. In one example, the first provider 26 is a completely separate entity from the vendor 20. The first provider 26 and the vendor 20 reach an agreement regarding the inclusion of the offering A 24 within the unit 22. The first provider 26 also markets offerings 28 and 30 but neither of those is included in the unit 22 in this example.

A second provider 32 markets offerings 34 and 36. Each of those are included in the unit 22 in this example.

Another offering 38 within the unit 22 in this example is available from a third provider 40, which also markets an offering 42 that is not included in the unit 22 in this example.

One example scenario includes the vendor 20 providing an open application programming interface (API) service and the unit 22 is a bundle of APIs. This invention is not necessarily limited, however, to any particular market or combination of offerings.

The vendor 20 is considered one of the providers for purposes of this description even though it does not independently market any of the individual offerings within the unit 22. The vendor 20 is considered a provider in that it provides the unit 22 or the offerings included in the unit to possible consumers. The vendor 20 is considered a provider for purposes of being one of the providers that shares in the revenues resulting from purchases of units 22 or offerings within the unit 22.

FIG. 2 schematically illustrates a device 50 that is useful for allocating revenue among the different providers 26, 32 and 40 and the vendor 20 resulting from purchases of units 22. This example includes a processor 52 that performs various functions for allocating revenue among the different providers of the offerings that are packaged together as the unit 22. The processor 52 may be a server or a computer, for example. One function of the processor 52 is to monitor purchases of units 22 or offerings from the unit 22. Accordingly, the example processor 52 includes a purchase monitoring module 54 configured to automate the process of tracking purchases or sales of units 22 or offerings in the unit. A virtual share issuance module 56 automatically issues virtual shares to the providers based on the number of unit or offering purchases and a pre-determined allocation of a number of virtual shares for each provider, respectively. A share pricing module 58 determines a value of each issued virtual share according to a selected revenue sharing rule and a determined schedule. One feature of the processor 52 is that the share pricing module 58 can use one or more revenue sharing rules that can be adjusted or customized to meet various situations or different requirements. This feature not only automates a pricing of the virtual shares but provides adaptability to achieve revenue sharing strategies or goals that are consistent with the intentions of the providers involved with marketing the unit 22.

The manner in which the virtual shares are issued by the processor 52 is based, in one example, on pre-negotiated contractual arrangements between the providers. For example, if the second provider 32, which provides two of the offerings 34 and 36 within the unit 22, has more bargaining power because of the presence of two of its offerings within the unit 22, the second provider 32 may contract for a first rate of share issuance. The first provider 26 and third provider 40 may receive fewer virtual shares per purchase of a unit 22 in one example. Similarly, the vendor 20 may have an ability to negotiate higher or lower numbers of virtual shares compared to the providers 26, 32 and 40 depending on the particular situation.

One feature of the illustrated example is that it accommodates different share allocations among different providers and accommodates different types of virtual shares. For example, each provider may receive a certain number of priority virtual shares and a certain number of ordinary virtual shares for each sale of a unit 22. Within this description, a number of virtual shares per purchase may be less than a whole number. For example, one of the providers may receive one virtual share for every five purchases of a unit 22. The example of FIG. 2 includes a contracting module 60 that is useful as an input, for example, to provide the processor 52 with appropriate information so that the share issuance module 56 issues virtual shares to the respective providers in an appropriate manner. The contracting module 60 and the share issuance module 56 accommodate a variety of ways in which the parties involved can contract to allocate or issue virtual shares. The share issuance module 56 automates the process of issuing virtual shares based upon a determined number of purchases of units 22 and the information from the contracting module 60.

There are different scenarios in which purchasers may make different types of purchases of units or offerings. In some situations, the purchaser will always purchase an entire unit that includes each of the offerings included in that unit. In other situations a purchaser may purchase one or more of the offerings without purchasing them all as a result of the offerings being offered as part of a unit. The contracting module 60 facilitates the vendors reaching a corresponding agreement for either type of situation.

In one example, each unit is a collection or set of local information sources each provided by an independent provider and consumers can obtain access to the unit or collection by paying a monthly subscription fee. For example, a frequent traveler likely would desire to have a subscription to the unit by paying a monthly fee. The subscriber in this example accesses one of the sources of information when in a first location (e.g., to get a schedule of the next train going to a desired destination from her current location). When the subscriber is in another location she accesses another source of information from another provider (e.g., to locate a nearby restaurant). Each time one of the sources is accessed, the purchase monitoring module considers it a “purchase” of the accessed offering. The share issuance module 56 issues the provider of that source an appropriate number of shares. In this example, there is no charge for each access but, rather, only the monthly subscription fee. The funds available from which providers can be paid for redeeming their shares is based on the total of all subscription fees collected during a month or other period.

Using a greeting card subscription as an example, the consumer pays a monthly subscription fee to gain access to text selections, photos, artwork and music for creating greeting cards. The greeting cards in one example are electronic and sent to an intended recipient over the Internet. In one example, there is one provider of text selections, several providers of photos, several providers of artwork and several providers of music. Each creation a greeting card by a subscriber will include one text selection and the subscriber's choice of a photo, artwork, music or a combination of these.

With the illustrated example, it is possible to accommodate various contractual arrangements between providers and to accommodate different ways in which “purchases” are made. According to one contractual agreement, the purchase monitoring module 54 determines which provider's artwork and music is included and the share issuance module 56 issues the appropriate number of shares to those providers. The providers that do not have one of their offerings will not get shares for that card in that example. According to another contractual agreement, the providers each get an appropriate number of shares for each card that is created through the subscription service. Given this description, those skilled in the art will realize how to arrange an appropriate share allocation and purchase accounting scheme to meet the needs of their particular situation.

In one example, the contracting module 60 effectively comprises a database of virtual share allocation rules that are consistent with negotiated terms among the different providers.

The share pricing module 58 in one example uses a selected rule for assigning a value to each virtual share according to a predetermined schedule. For example, the virtual shares may be issued by the share issuance module 56 on an ongoing basis responsive to ongoing sales of units 22. The share pricing module 58 in one example assigns a value to issued virtual shares on a monthly basis. The rule used for assigning a value to each issued virtual share may be selected according to an arrangement negotiated by the involved providers, for example.

The automated virtual share pricing performed by the processor 52 allows for flexibility in selecting different rules for different types of virtual shares (e.g., priority virtual shares compared to ordinary virtual shares) and for different circumstances. For example, different share pricing rules may be implemented by the processor 52 depending upon factors such as the currently outstanding number of issued virtual shares, the current amount of available revenue for share redemption, the current number of virtual shares for which a redemption request is being made or a combination of these. Different scenarios and circumstances may require or suggest different share pricing rules to meet the business objectives agreed upon by the providers.

One example revenue sharing rule that is used for setting the value or redemption price of a virtual share proportionally distributes available revenue among the issued virtual shares. One such rule operates according to known proportional revenue sharing schemes. For example, for each purchase of a unit, each provider receives a number of ordinary virtual shares. Issued virtual shares can then be redeemed at scheduled redemption intervals at a per-share price that is set based upon the total revenue available in that redemption interval divided by the total number of outstanding virtual shares.

Another revenue sharing or share pricing rule operates based upon a known priority cost recovery scheme. In one such example, each provider receives a number of priority virtual shares corresponding to its cost and a pre-negotiated number of ordinary virtual shares. For share redemption purposes, the priority virtual shares are redeemed first at a per-share price that corresponds to the total revenue or total cost of the offerings, whichever is smaller, divided by the total number of outstanding priority virtual shares. Any remaining revenue is shared proportionally based upon the number of ordinary virtual shares. In one example, each provider receives the same number of ordinary virtual shares and any remaining or residual revenue is shared equally among them.

Another example revenue sharing rule allocates revenue to a first type of virtual shares on a priority basis and then allocates revenue to a second, different type of virtual share proportionally based upon any remainder after the revenue is allocated to the first type of virtual shares. One such example follows the Talmud law revenue sharing scheme. For example, each purchase of a unit 22 results in a provider receiving an equal number of priority and ordinary virtual shares. A provider that redeems a priority virtual share receives the unit price for that virtual share. Any residual or remaining revenue after all priority virtual shares have been redeemed is shared proportionally based on the number of ordinary virtual shares. In a case where there are insufficient funds to redeem all priority shares, the providers can redeem these shares up to a common upper limit at which point the available revenue runs out. If there are sufficient funds to redeem all priority shares but not all ordinary shares, a provider can redeem all priority shares, but has to forfeit the smaller of a number of ordinary shares, which is common to all providers, or all of its ordinary shares to the point where there are enough funds to redeem all priority shares and remaining ordinary shares at the unit price.

Other known revenue sharing schemes may be applied as the revenue sharing rule used by the share pricing module 58. It is possible for the providers to negotiate an arrangement that controls which rule is applied depending upon the circumstances in a given redemption interval. For example, when there is a large amount of revenue, one rule may be applied but a different rule will be applied if the available revenue in a share redemption interval is below a selected threshold. Being able to customize and automate the manner in which virtual share pricing is accomplished allows for greater flexibility and a more attractive revenue sharing option among providers.

The example of FIG. 2 also includes a share redemption module 62 that facilitates making payments to a redeemer of issued virtual shares. The participating vendors can negotiate how much flexibility they have regarding share redemption. For example, some arrangements will require redemption of all outstanding shares at each redemption opportunity or interval. Other arrangements will allow any of the participating vendors (or share owners) to redeem shares at any available redemption period.

In one example, any one of the providers may redeem their virtual shares during a redemption interval. A provider may redeem any number of virtual shares during a given redemption interval (assuming that the virtual share pricing rule for that interval does not place a limit on the number of virtual shares that can be redeemed by that provider). A provider may hold onto all or some of its virtual shares during any particular pricing interval. This allows a provider the flexibility to wait for a redemption interval in which the virtual share price will be higher so that the provider may maximize its return based upon its participation in the marketing of it offerings that are part of the unit 22. The share redemption module 62 includes an appropriate interface in one example between providers, the facilitator of the revenue sharing arrangement and appropriate payment facilities such as banks, for example.

In one example, the issued virtual shares can be held on to by a provider, redeemed by a provider or traded by the provider to another entity. Providers may exchange virtual shares for capital, goods or services with other providers or other entities not involved in providing the offerings that are included in the unit 22. The share redemption module 62 in one example facilitates any legitimate redeemer of legitimately issued virtual shares receiving payment in an amount corresponding to the current virtual share price. This feature of the illustrated example allows for creating a virtual stock market of the virtual shares that are issued to the providers. Selling virtual shares at various times may allow for a provider to obtain capital in exchange for liquidating their virtual shares even at times when share redemption is not available directly through the share redemption module 62. Additionally, providers may be able to sell their virtual shares to reduce their exposure to the risk of a low redemption price, for example. Entities separate from the providers may find it desirable to obtain virtual shares from one or more of the providers and then redeem them at a time when the redemption price is relatively high.

The feature of allowing for a virtual stock market of the virtual shares issued to the providers also provides the ability for the facilitator of the device 50 to charge transactional fees associated with selling or redeeming virtual shares on such a virtual stock market. In one example, the facilitator of the device 50 is the vendor 20. In another example, a third party facilitates operating the device 50 to facilitate the revenue sharing among the different providers. In still another example, one of the providers 26, 32 or 40 facilitates operation of the device 50 and obtains compensation for facilitating the revenue sharing scheme.

In one example, at least one of the share issuance module 56 or the share redemption module 62 includes an online account of the number of shares currently held by each vendor or share owner. The number of virtual shares in the account for each provider depends on share issuance according to offering or unit purchases and redemption of shares, respectively. The accounts may be provided and managed by the facilitator of the device 50 or a third party.

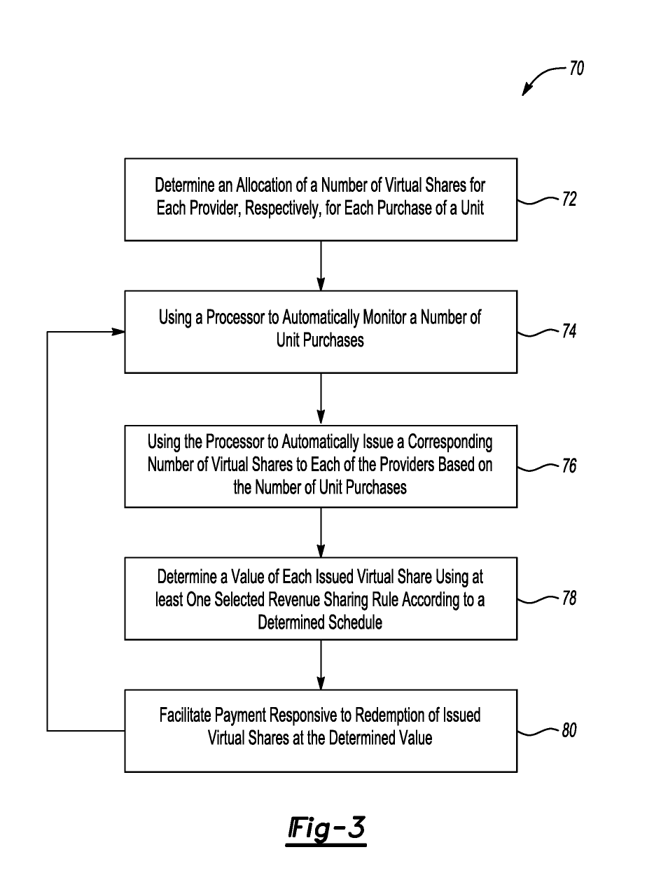

FIG. 3 includes a flowchart diagram 70 that summarizes an example approach for allocating revenue among different providers of different offerings that are packaged together to be sold as a unit. An allocation of a number of virtual shares for each provider, respectively, is determined at 72. The processor 52 automatically monitors the number of unit purchases at 74. At 76, the processor 52 automatically issues a corresponding number of virtual shares to each of the providers based on the number of unit purchases. The value of each issued virtual share is determined using at least one selected revenue sharing rule according to a determined schedule at 78. As indicated at 80, payment responsive to redemption of issued virtual shares at the currently determined value is facilitated by the share redemption module 62.

While the contracting module 60 and the share redemption module 62 are schematically illustrated as being separate from the processor 52 in FIG. 2, each of those may be part of a single processor or server, for example. In other words, in some examples the processor 52 includes the contracting module 60, the share redemption module 62 or both. The schematic divisions shown in FIG. 2 are for discussion purposes only. Given this description, those skilled in the art realize what combination of hardware, software or firmware will allow them to realize the functionality of the example device 50 for meeting the needs of their particular situation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A device for allocating revenue among providers of offerings that are each offered as part of a unit, the device comprising:
a processor that is configured to
automatically determine a number of unit or offering purchases,
automatically issue a number of virtual shares to each of the providers based on the determined number of unit or offering purchases and a predetermined allocation of a number of virtual shares for each provider, respectively, corresponding to each purchase of a unit or offering, and
determine a value of each issued virtual share using at least one selected revenue sharing rule according to a determined schedule; and
a virtual share redemption module that is configured to facilitate redemption of issued virtual shares at the determined value.

2. The device of claim 1, wherein there are a plurality of types of virtual shares and the processor uses a first revenue sharing rule for determining the value of issued virtual shares of a first type and a second, different revenue sharing rule for determining the value of issued virtual shares of a second type.

3. The device of claim 2, wherein the predetermined allocation for each provider includes an allocation of the first type of virtual shares and an allocation of the second type of virtual shares.

4. The device of claim 1, wherein the processor includes the virtual share redemption module.

5. The device of claim 4, wherein the virtual share redemption module
permits virtual share redemption at scheduled intervals corresponding to the determined schedule used by the processor; and
permits any number of the issued shares to be redeemed at one of the scheduled intervals and wherein each issued virtual share is redeemable at one of the intervals regardless of when the virtual share was issued.

6. The device of claim 4, wherein the virtual share redemption module facilitates share redemption of at least one of the issued virtual shares by a redeemer that is one of the providers or a purchaser of at least one of the issued virtual shares from one of the providers.

7. The device of claim 1, wherein the selected revenue sharing rule is selectively changeable.

8. The device of claim 1, wherein the revenue sharing rule proportionally distributes revenue among the issued virtual shares.

9. The device of claim 1, wherein the revenue sharing rule values each virtual share based on recovering provider cost followed by proportionally distributing revenue among the issued virtual shares.

10. The device of claim 1, wherein the revenue sharing rule allocates revenue to a first type of virtual shares on a priority basis and then allocates revenue to a second, different type of virtual share proportionally based on any remainder after the revenue is allocated to the first type of virtual shares.

11. A method of allocating revenue among providers of offerings that are offered as part of a unit, comprising the steps of:
determining an allocation of a number of virtual shares for each provider, respectively, corresponding to each purchase of a unit or offering;
using a processor for automatically determining a number of unit or offering purchases;
using the processor for automatically issuing a number of virtual shares to each of the providers based on the determined number of unit or offering purchases and the determined allocation;
using the processor for determining a value of each issued virtual share using at least one selected revenue sharing rule according to a determined schedule; and
facilitating redemption of issued virtual shares at the determined value.

12. The method of claim 11, wherein there are a plurality of types of virtual shares and the method includes using a first revenue sharing rule for determining the value of issued virtual shares of a first type and a second, different revenue sharing rule for determining the value of issued virtual shares of a second type.

13. The method of claim 12, wherein the predetermined allocation for each provider includes an allocation of the first type of virtual shares and an allocation of the second type of virtual shares.

14. The method of claim 11, wherein facilitating redemption of issued virtual shares occurs at scheduled intervals corresponding to the determined schedule.

15. The method of claim 14, comprising permitting any number of the issued virtual shares to be redeemed at one of the scheduled intervals and wherein each issued virtual share is redeemable at one of the intervals regardless of when the virtual share was issued.

16. The method of claim 14, comprising facilitating share redemption of at least one of the issued virtual shares by a redeemer that is one of the providers or a purchaser of at least one of the issued virtual shares from one of the providers.

17. The method of claim 11, comprising selectively changing the revenue sharing rule.

18. The method of claim 11, wherein the revenue sharing rule proportionally distributes revenue among the issued virtual shares.

19. The method of claim 11, wherein the revenue sharing rule values each virtual share based on recovering provider cost followed by proportionally distributing revenue among the issued virtual shares.

20. The method of claim 11, wherein the revenue sharing rule allocates revenue to a first type of virtual shares on a priority basis and then allocates revenue to a second, different type of virtual share proportionally based on any remainder after the revenue is allocated to the first type of virtual shares.
